(19) United States
(12) Patent Application Publication
(10) Pub. No.: US 2025/0019237 A1
(43) Pub. Date: Jan. 16, 2025

(54) RECYCLE OF BYPRODUCTS TO PROVIDE A GREEN HYDROGEN STREAM FOR A METHANOL TO JET FUEL PROCESS

(71) Applicant: UOP LLC, Des Plaines, IL (US)

(72) Inventors: Ian G. Horn, Streamwood, IL (US); John J. Senetar, Naperville, IL (US); Eseoghene Jeroro, Chicago, IL (US)

(21) Appl. No.: 18/772,154

(22) Filed: Jul. 13, 2024

Related U.S. Application Data
(60) Provisional application No. 63/513,847, filed on Jul. 14, 2023.

(51) Int. Cl. C01B 3/50

(52) U.S. Cl. CPC C01B 3/50; C01B 2203/0283; C01B 2203/042; C01B 2203/047; C01B 2203/0475; C01B 2203/048; C01B 2203/065

(57) ABSTRACT

In methanol to jet fuel complexes there is a need for hydrogen for several different processes including hydrogenation. Hydrogen is produced by steam methane reforming and from water gas shift reactions. Greater efficiencies are provided by sending off-gas streams from columns including demethanizer, dealkanizer, and a stripper to the reforming reactors to increase the amount of hydrogen available.

### FIELD

The field is the conversion of olefins to distillate. The field may particularly relate to the use of byproducts to produce hydrogen.

### BACKGROUND

Molecular sieves such as microporous crystalline zeolite and non-zeolitic catalysts, particularly silicoaluminophosphates (SAPO), are known to promote the conversion of oxygenates such as methanol to light olefins. The highly efficient methanol to olefin (MTO) process may convert oxygenates to light olefins which had been typically considered for plastics production. Light olefins produced from the MTO process is highly concentrated in ethylene and propylene.

The ethanol dehydration process involves dehydration of ethanol molecules to generate ethylene and water. The process of converting ethanol to ethylene is endothermic in nature and the heat of endothermicity is typically provided by fired heaters to an adiabatic reactor.

Ethylene can be oligomerized into olefins such as C4, C6 and C8 olefins. Propylene can be oligomerized into olefins such as C6, C9 and C12 olefins. Olefin oligomerization is a process that can oligomerize smaller olefins into larger olefins. More specifically, it can convert olefins including oligomerized olefins into distillates including jet fuel and diesel range products. The oligomerized distillate can be saturated for use as transportation fuels.

Jet fuel is one of the few petroleum fuels that cannot be replaced easily by electrical motor systems because a high energy output is required to fuel planes which cannot be supplied with electric motors. Jet fuel has an end point boiling specification of less than 300° C. using ASTM D86. Large incentives are currently available for green jet fuel in certain regions.

The oligomerization unit requires hydrogen in order to meet the requirements for sustainable jet fuel. An improved process is provided to recycle hydrogen-rich off-gas streams to supplement the hydrogen produced by reforming.

### BRIEF SUMMARY

A process for providing hydrogen in a process to produce jet fuel from methanol is disclosed. The process comprises sending a hydrocarbon rich off-gas stream to a reforming reactor or a partial oxidation reactor to produce a gas stream. The gas stream may be reacted in a water-gas shift reactor to increase hydrogen produced. A hydrogen rich off-gas stream is sent to be combined with the gas stream to provide a hydrogen enhanced gas stream. The hydrogen enhanced gas stream is purified to produce a hydrogen stream. The off-gas streams are taken from one or more columns selected from a demethanizer column, dealkanizer column, stripper column, and jet fractionator column.

### BRIEF DESCRIPTION OF THE DRAWINGS

FIG. 1 is a schematic drawing of a process for providing hydrogen in a process to produce jet fuel from methanol in accordance with an embodiment of the present disclosure.

FIG. 2 is a schematic drawing of a process for providing hydrogen in a process to produce jet fuel from methanol in accordance with an alternate embodiment of the present disclosure.

FIG. 3 is a schematic drawing of an oligomerization feed production unit in accordance with an exemplary embodiment of the present disclosure.

FIG. 4 is a schematic drawing of an oligomerization section in accordance with another exemplary embodiment of the present disclosure.

FIG. 5 is a schematic drawing of a hydrogenation section in accordance with yet another exemplary embodiment of the present disclosure.

### DEFINITIONS

The term “communication” means that fluid flow is operatively permitted between enumerated components, which may be characterized as “fluid communication”.

The term “downstream communication” means that at least a portion of fluid flowing to the subject in downstream communication may operatively flow from the object with which it fluidly communicates.

The term “upstream communication” means that at least a portion of the fluid flowing from the subject in upstream communication may operatively flow to the object with which it fluidly communicates.

The term “direct communication” means that fluid flow from the upstream component enters the downstream component without passing through any other intervening vessel.

The term “indirect communication” means that fluid flow from the upstream component enters the downstream component after passing through an intervening vessel.

The term “bypass” means that the object is out of downstream communication with a bypassing subject at least to the extent of bypassing.

As used herein, the term “predominant” or “predominate” means greater than 50%, suitably greater than 75% and preferably greater than 90%.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripping columns may omit a reboiler at a bottom of the column and instead provide heating requirements and separation impetus from a fluidized inert media such as steam. Stripping columns typically feed a top tray and take main product from the bottom.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure. As used herein, the term “boiling point temperature” means atmospheric equivalent boiling point (AEBP) as calculated from the observed boiling temperature and the distillation pressure, as calculated using the equations furnished in ASTM D1160 appendix A7 entitled “Practice for Converting Observed Vapor Temperatures to Atmospheric Equivalent Temperatures”.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T5”, “T90” or “T95” means the temperature at which 5 mass percent, 90 mass percent or 95 mass percent, as the case may be, respectively, of the sample boils using ASTM D-86 or TBP.

As used herein, the term “initial boiling point” (IBP) means the temperature at which the sample begins to boil using ASTM D-7169, ASTM D-86 or TBP, as the case may be.

As used herein, the term “end point” (EP) means the temperature at which the sample has all boiled off using ASTM D-7169, ASTM D-86 or TBP, as the case may be.

As used herein, the term “diesel” means hydrocarbons boiling in the range of an IBP between about 125° C. (257° F.) and about 175° C. (347° F.) or a T5 between about 150° C. (302° F.) and about 200° C. (392° F.) and the “diesel cut point” comprising a T95 between about 343° C. (650° F.) and about 399° C. (750° F.) using the TBP distillation method or a T90 between 280° C. (536° F.) and about 340° C. (644° F.) using ASTM D-86. The term “green diesel” means diesel comprising hydrocarbons not sourced from fossil fuels.

As used herein, the term “jet fuel” means hydrocarbons boiling in the range of a T10 between about 190° C. (374° F.) and about 215° C. (419° F.) and an end point of between about 290° C. (554° F.) and about 310° C. (590° F.). The term “green jet fuel” means jet fuel comprising hydrocarbons not sourced from fossil fuels.

As used herein, the term “predominant” or “predominate” means greater than 50%, suitably greater than 75% and preferably greater than 90%.

As used herein, the term “a component-rich stream” or “rich stream” means that the rich stream coming out of a vessel has a greater concentration of the component than the feed to the vessel and preferably than all other streams withdrawn from the vessel.

As used herein, the term “a component-lean stream” or “lean stream” means that the lean stream coming out of a vessel has a smaller concentration of the component than the feed to the vessel and preferably than all other streams withdrawn from the vessel.

As used herein, the term “rich” means greater than 5%, suitably greater than 10% and preferably greater than 25%.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

### DETAILED DESCRIPTION

A process is provided for converting methanol to jet fuel. This process may start with methanol derived from a biological source, at least in part, and other or all methanol may be derived from a petroleum source. In the present disclosure, methanol is supplied to the process that may be made at a different site. The resultant methanol is then contacted with an MTO catalyst to produce an olefin stream. The methanol may be sent to a methanol to olefins reactor to produce a light olefin stream mainly comprising ethylene and propylene but with some impurities including higher molecular weight olefins, alkanes, carbon dioxide and hydrogen. The light olefin stream is treated in a oligomerization feed production unit 101 in which the dried liquid and vapor olefin product is fractionated and sent to an oligomerization process and then to a hydrogenation process to produce the jet fuel as well as renewable diesel and naphtha streams. It has been found that off-gas streams may be sent to a steam reformer or autothermal reformer to produce hydrogen that can be used in the process.

The process and apparatus disclosed may involve the production of a liquid fuel from carbon dioxide and hydrogen. The process may comprise reacting a mixture of carbon dioxide and hydrogen to produce methanol, carbon monoxide, and water. The methanol is contacted with an MTO catalyst to produce an olefin stream. The olefin stream is oligomerized with an oligomerization catalyst to produce an oligomerized olefin stream comprising jet fuel and diesel fuel. A syngas stream is produced comprising carbon oxides and hydrogen by (1) reforming hydrocarbon off-gases from the process with steam in a steam reforming reactor, an autothermal reforming reactor, a dry reforming reactor; or (2) partially oxidizing said the hydrocarbon off-gas stream. The syngas stream can be further reacted in a water gas shift reactor to produce more hydrogen.

There are three alternatives to the approach of producing the syngas with hydrocarbons that can come from MTJ off-gas streams:
(1) Steam reforming at high temperatures with methane and steam will create a syngas mixture that can be fed directly to water gas shift reactor. Steam reforming is an endothermic process, so requires a substantial amount of external heat.
(2) Autothermal reforming combines both partial oxidation and steam reforming. Oxygen from a hydrolysis unit or from air, and hydrocarbons are partially combusted perhaps over a catalyst to produce an appropriate syngas mixture.
(3) Dry reforming may also be employed. Methane and carbon dioxide is reacted over a catalyst in an endothermic process to form a syngas mixture of hydrogen and carbon monoxide.

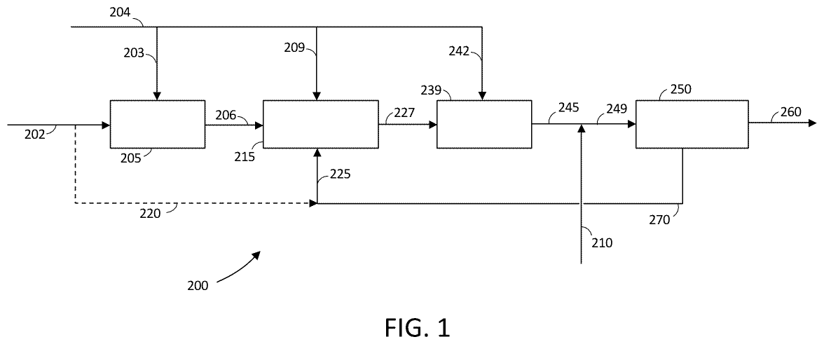

FIG. 1 shows a process and apparatus 200 that provides hydrogen as needed to the process. A hydrocarbon-rich off-gas stream in line 202 is taken from one or several different columns in an oligomerization feed production unit 101 and an oligomerization unit 201 as a feed to the process. In an embodiment, the hydrocarbon rich off-gas stream in line 202 is rich in hydrocarbons.

Optionally, the feed in line 202 is reacted with a steam stream in line 203 from a steam header 204 over a pre-reforming catalyst in a pre-reforming reactor 205 to break larger hydrocarbons into smaller hydrocarbons like methane that are more easily reacted in a steam reforming reaction. Pre-reforming protects a downstream steam methane reforming (SMR) reactor 215 from excessive coking. Pre-reforming reactions in the pre-reforming reactor 205 also produce carbon oxides, hydrogen, and water. Typically, the pre-reforming reactor 205 may be operated at a temperature of about 380° C. to about 550° C. over a pre-reduced high-Ni based catalyst. The conversion of large hydrocarbons to small hydrocarbons such as methane and carbon oxide, hydrogen, and water helps achieve similarity with respect to the constituent gases usually handled in the main reformer at higher temperature. A pre-reformed stream in line 206 is transported to a steam methane reforming (SMR) unit 215 with a flow of steam stream in line 209 from line 204.

Steam reforming the hydrocarbon gas streams at high temperatures with carbon dioxide and steam will create a syngas mixture. This is an endothermic process that requires a substantial amount of external heat. Steam reforming of hydrocarbons can generally be represented with the chemical equation:

CₙHₘ+nH₂O→nCO+(n+m/2)H₂

For methane, this becomes:

CH₄+H₂O→CO+3H₂ ΔH°298K=+206 KJ/mol

The hydrocarbon gas stream is mixed with one to two carbon equivalents of carbon dioxide to prevent elemental carbon production. Carbon dioxide may be present in the hydrocarbon gas stream or it can be added from other plant streams. The hydrocarbon gas stream and carbon dioxide mixture is then mixed with steam to produce a mixture comprising about 1 mol carbon from hydrocarbons and 1 to 2 moles water. The gas/steam mixture enters the SMR reactor 215 charged with a commercially available nickel catalyst. The conversion of the hydrocarbons to carbon monoxide and hydrogen takes place at about 700° C. to about 900° C. at a system pressure that may be between 82 kPa (abs) (12 psia) and about 3.5 MPa (abs) (500 psia). A typical flow rate for such a reactor would be about 4806 kg/hr/cubic meter (300 lbs/hr/cubic foot) of catalyst.

SMR uses a catalyst at very high temperatures. A typical SMR catalyst may comprise nickel on alumina. This is a highly endothermic reaction so it requires an external fuel stream to provide the heat of reaction. A portion of the off-gas stream in line 202 may be diverted in line 220 to provide fuel in line 225 for heating requirements in the SMR reactor 215. Alternatively, a tail gas stream in line 270 from the pressure swing adsorption unit 250 may be used to provide fuel to the steam methane reforming unit 215. Steam reforming or SMR produces syngas (hydrogen and carbon monoxide) by reaction of hydrocarbons with water. The SMR reactor 215 may comprise one or more packed bed reactors for producing syngas from the pre-reformed stream in line 206.

The syngas from the steam methane reforming unit 215 is taken in line 227 and fed to a water gas shift reactor 239 with another steam stream in line 242 to convert carbon monoxide and water to produce additional hydrogen and carbon dioxide. The water gas shift reaction in the water gas shift reactor 239 includes reacting carbon monoxide and water vapor to form carbon dioxide and additional hydrogen. Thus, the water gas shift reactor 239 produces more hydrogen in addition to the hydrogen present in the syngas stream in line 227.

The water-gas shift reaction comprises charging the syn gas over a water gas shift catalyst in the presence of steam at an elevated temperature. The carbon monoxide and steam react to form hydrogen and carbon dioxide, as shown in the chemical equation

CO+H₂O→CO₂+H₂

The watergas shift catalyst may comprise at least one metal selected from iron, cobalt, nickel, copper, zinc, yttrium, zirconium, niobium, molybdenum, technetium, ruthenium, rhodium, palladium, silver, cadmium, lanthanum, hafnium, tantalum, tungsten, rhenium, osmium, indium, platinum, gold, and mercury. Preferably, the watergas shift metal is deposited on a support. Materials suitable for supports include, but are not limited to, inorganic oxides such as silicas, aluminas, titania, zirconia, yttria, and molecular sieves. Other supports include, but are not limited to, carbon, silicon carbide, diatomaceous earth, and clays. Operating temperatures for the water gas shift reaction may range from about 100° C. (212° F.) to about 345° C. (653° F.), or from about 150° C. (302° F.) to about 300° C. (572° F.) and with pressures from about 3.1 MPa (450 psig) to about 17.3 MPa (2500 psig), or from about 3.5 MPa (500 psig) to about 6.9 MPa (1000 psig).

The water gas shift reactor effluent comprising hydrogen and carbon dioxide is taken in line 245 from the water gas shift reactor 239 and fed to the PSA unit 250 to purify the hydrogen. The products from the water gas shift reactor 239 have a mix of hydrogen, CO₂, CO, and unconverted methane. The PSA product gas is a high-purity hydrogen stream and the tail gas contains CO₂, CO, and unconverted methane separated from the hydrogen in line 270, which can be used as fuel for the SMR reactor 215.

In addition, a hydrogen-rich off-gas stream in line 210 may be added to the water gas shift reactor effluent stream in line 245 from the water gas shift reactor 239 to provide a hydrogen enhanced gas stream in line 249 to be purified in the PSA unit 250. In an embodiment, the hydrogen-rich off-gas stream in line 210 is rich in hydrogen, such as comprising at least 10 mol % hydrogen. In an embodiment, the hydrogen rich off-gas stream in line 210 predominantly comprises hydrogen.

Typically, the PSA unit 250 includes a series of multiple adsorbent beds containing one or a combination of multiple adsorbents suitable for adsorbing the particular components to be adsorbed therein. These adsorbents include, but are not limited to, activated alumina, silica gel, activated carbon, zeolitic molecular sieves, or any combination thereof. The adsorbents are organized in any sequence as required by the adsorption process to adsorb impurities. In the PSA unit, the hydrogen enhanced gas stream in line 249 flows over the adsorbents and the larger impurities are adsorbed during the adsorption step while hydrogen passes through to provide a hydrogen product stream in hydrogen product line 260. The hydrogen product stream is at least 95 mol % hydrogen but preferably at least 98 mol % hydrogen. Periodically, flow to the adsorbent bed is terminated and pressure reduced, so the impurities will exit the bed in the tail gas stream in line 270.

In FIG. 1, the off-gas from the column in line 202 is the net overhead vapor stream from one or several process units not shown in FIG. 1 including a demethanizer column, a dealkanizer column, and a jet fractionator column. If the off-gas is hydrogen rich, then it will be routed to the PSA unit 250 in line 210 to recover hydrogen. If the off-gas is hydrocarbon rich, it will be routed to the SMR reactor 215 perhaps through the pre-reforming reactor 205. The dealkanizer off-gas stream would be the best candidate as feed in line 202, while the stripper off-gas would be the best candidate as a feed stream in line 210. If carbon monoxide and unconverted methane from the PSA unit is insufficient to provide the necessary heat of reaction in the SMR, then additional fuel gas can be supplied from the off-gas from the columns. If the off-gas is not hydrogen rich or hydrocarbon rich, then it may be directed to the SMR reactor 215 as fuel.

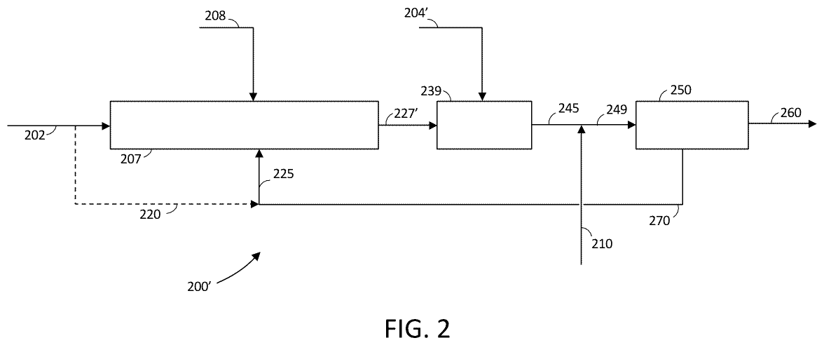

FIG. 2 shows an alternate embodiment 200′ of the process that provides hydrogen as needed to the process. Elements in FIG. 2 with the same configuration as in FIG. 1 will have the same reference numeral as in FIG. 1. Elements in FIG. 2 which have a different configuration as the corresponding element in FIG. 1 will have the same reference numeral but designated with a prime symbol (′). The configuration and operation of the embodiment of FIG. 2 is essentially the same as in FIG. 1 with the following exceptions.

FIG. 2 comprises a partial oxidation unit 207 for converting the off-gas stream in line 202 to produce syngas. The partial oxidation unit 207 replaces the SMR reactor 215 and perhaps the pre-reforming reactor 205 of FIG. 1. The partial oxidation reaction is an exothermic process, using oxygen perhaps from air or from an electrolyzer to combust or catalytically react with a fuel to generate carbon monoxide and water. Oxygen provided is less than stochiometric to promote production of carbon monoxide over carbon dioxide.

As shown, the off-gas stream in line 202 is passed to the partial oxidation unit 207. An oxygen containing stream is also passed to the partial oxidation unit 207 in line 208. The off-gas stream in line 202 is partially oxidized in the partial oxidation unit 207 to produce carbon monoxide and water which is charged in line 227′ to the water gas shift reactor 239 to convert carbon monoxide and water to hydrogen and carbon dioxide. The rest of the process is same as previously described in FIG. 1.

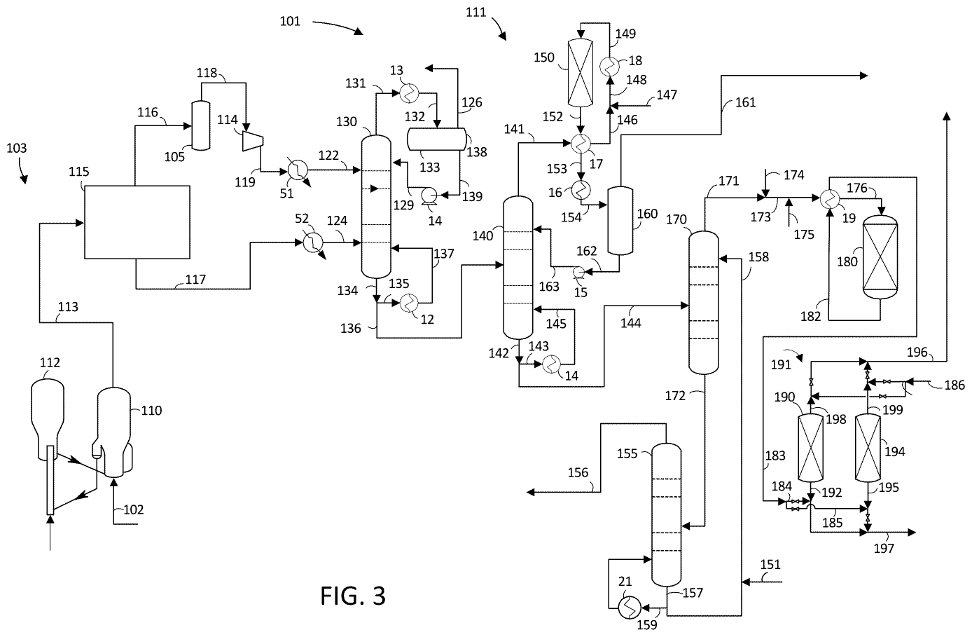

FIG. 3 shows an oligomerization feed production unit 101. In accordance with the present disclosure, one or both of the off-gas stream in line 202 and the hydrogen rich off-gas stream in line 210 in FIG. 1 and/or FIG. 2 may be taken from the oligomerization feed production unit 101 of FIG. 3. As shown, the oligomerization feed production unit 101 comprises an oxygenate conversion section 103 and an oligomerization feed preparation section 111. The oxygenate conversion section 103 may be a methanol to olefins (MTO) unit. The oxygenate conversion section 103 comprises an oxygenate conversion reactor 110 and an olefins separation 115. A methanol charge stream is taken in line 102 and charged to the oxygenate conversion reactor 110. In an aspect, the methanol charge stream in line 102 may comprise one or more oxygenates including methanol, dimethyl ether, ethanol or combinations thereof. In an exemplary embodiment, the methanol in the methanol charge stream in line 102 is derived from a biological source. In the oxygenate conversion reactor 110, the charge stream is contacted with an MTO catalyst at MTO reaction conditions to convert methanol to olefins and water. The MTO catalyst may be in a fluidized state in the oxygenate conversion reactor 110.

Methanol is converted into light olefin products in a methanol to olefin (MTO) process. Molecular sieves such as microporous crystalline zeolite and non-zeolitic catalysts, particularly silicoaluminophosphates (SAPO), promote the conversion of oxygenates such as methanol to hydrocarbon mixtures, particularly hydrocarbon mixtures composed largely of light olefins. SAPO catalysts and their formulation are generally taught in U.S. Pat. Nos. 4,499,327A, 10,358,394 and 10,384,986. Light olefins produced from the MTO process are concentrated in ethylene and propylene but include C4-C6 olefins. In an embodiment, the MTO catalyst may be a SAPO catalyst.

The MTO reaction conditions in the oxygenate conversion reactor 110 include contact with a SAPO catalyst at a pressure between about 100 kPa (a) (14 psia) and about 700 kPa (a) (100 psia). The MTO reaction temperature should be between about 400° C. (750° F.) to about 510° C. (980° F.). A weight hourly space velocity (“WHSV”) in the oxygenate conversion reactor 110 is in the range of about 1 to about 15 hr⁻¹.

The MTO catalyst is separated from the product olefin stream after the MTO reaction. A hot vaporous reactor effluent stream in line 113 is withdrawn from the oxygenate conversion reactor 110 which periodically or continuously circulates fluidized catalyst in a conventional manner to the regeneration zone 112 to maintain the selectivity and the conversion desired. The hot vaporous reactor effluent stream in line 113 carries the product olefins from the oxygenate conversion reactor 110. Olefins are recovered from the hot vaporous reactor effluent stream in line 113 in the separation section 115.

The separation section 115 may comprise one or more of a quench tower, a product separator column, a compression section, a water stripper column, and a distillation column. In the separation section 115, the hot vaporous reactor effluent stream in line 113 may be passed to the quench tower where it is desuperheated, neutralized of organic acids and clarified of catalyst fines by direct contact with a water stream. A quenched reactor effluent stream is discharged from the quench tower and fed to the product separator column. The product separator column may comprise more than one section for separating the quenched reactor effluent stream into a product olefin stream in the overhead, an intermediate liquid stream and a bottoms water stream. The bottoms water stream may be passed to the water stripper column. The product olefin stream in the product separator overhead stream carries valuable olefinic products which must be recovered. The product separator overhead stream is passed to the compression section which increases the pressure of the product olefin stream necessary for downstream processing such as used in conventional light olefin recovery units. A pressurized olefin rich stream is taken from the compression section and passed to an oxygenate absorber column to absorb at least a quantity of effluent oxygenates with a water stream. A contacted olefin rich stream is passed to an absorber separator in which gaseous olefins are taken in the overhead. The gaseous olefins are passed to a stripper which separates an aqueous stream including oxygenates, a light olefinic vapor stream comprising C3− olefins in the overhead and a heavy olefinic liquid stream comprising C4+ olefins in the bottoms. The light olefinic vapor stream may be scrubbed in a caustic scrubber column, refrigerated in a chiller to liquefy part of the scrubber light olefinic stream and separated in a drier separator to provide a vaporous light olefin stream comprising C2− hydrocarbons and gases in an overhead line 116 and a liquid light olefin stream in a comprising C3+ hydrocarbons in a bottoms line 117. The product olefin streams in lines 116 and 117 are processed in the oligomerization feed preparation section 111 to prepare one or more feed streams for oligomerization.

In an embodiment, the vaporous light olefin stream in line 116 may be fed to a demethanizer fractionation column 130. The vaporous light olefin stream in line 116 may be fed to the top half of the demethanizer fractionation column 130. In an aspect, the vaporous light olefin stream in line 116 may be passed to a first suction drum 105 and the overhead stream in line 118 from the first suction drum 105 is compressed in a first compressor 114. A compressed vaporous light olefin stream may be taken in line 119 from the first compressor 114 and passed to a first heat exchanger 51. A cooled vaporous light olefin stream is taken in line 122 from the first heat exchanger 51 and passed to the demethanizer fractionation column 130.

In an embodiment, the liquid light olefin stream in line 117 may be fed to the demethanizer fractionation column 130. The liquid light olefin stream in line 117 may be fed to the bottom half of the demethanizer fractionation column 130. In an aspect, the liquid light olefin stream in line 117 may be passed to a second heat exchanger 52. A heated liquid light olefin stream is taken in line 124 from the second heat exchanger 52 and passed to the demethanizer fractionation column 130. The vaporous light olefin stream and the liquid light olefin stream may be fractionated in the demethanizer fractionation column 130 together.

In an embodiment, the vaporous light olefin stream in line 119 and the liquid light olefin stream in line 117 may be combined and passed to a combined heat exchanger (not shown). A combined heat exchanged stream may be separated in the demethanizer fractionation column 130.

The vaporous light olefin stream and the liquid light olefin stream are fractionated preferably together in the demethanizer fractionation column 130 to provide an overhead light gas stream in an overhead light gas line 131 and a bottom olefin rich stream in a bottoms line 134 which may be considered a demethanized olefin rich stream. The overhead light gas stream in line 131 may comprise light gases of methane and lighter gases such as carbon monoxide, carbon dioxide, methane, nitrogen and hydrogen. Essentially all of the carbon monoxide will exit in the overhead light gas stream in line 131. The overhead light gas stream in line 131 is condensed in a demethanizer condenser 13 and fed to a demethanizer receiver 138. Condensed light gases are refluxed from the demethanizer receiver 138 to column 130 in a reflux line 139 while the light gas stream is taken in a net overhead line 126. The reflux stream may be passed to a pump 14 and a pumped reflux stream in line 129 is recycled to the demethanizer fractionation column 130. A hydrogen-rich gas stream can be taken in line 128 as an off-gas stream in line 210 of FIGS. 1 and 2. In an embodiment, all of the light gas stream in the net overhead line 126 is taken to the oxygenate conversion reactor 110.

The light gas stream in the net overhead line 126 may comprise hydrogen in substantial amount which can be recovered from the off gas. In an embodiment, the light gas stream in line 126 or the purge gas stream in line 127 may be passed to the pressure swing adsorption unit 250 in FIG. 1 and/or FIG. 2 to recover hydrogen from the off gases. In an aspect, the light gas stream in line 126 or one or both of the fuel gas stream in line 128 and the purge gas stream in line 127 may be taken in the H2 rich off-gas stream in line 210 and passed to the pressure swing adsorption unit 250 in FIG. 1 and/or FIG. 2.

The olefin rich stream comprising C2+ olefins, typically C2-C8 olefins, in the demethanizer bottoms line 134 may be split into a reboil stream in line 135 which is reboiled in a demethanizer reboiler 12 and a reboiled stream in line 137 is returned to the column. A net olefin rich stream is taken in a net bottoms line 136. The demethanizer bottoms temperature may be about 0° C. (32° F.) to about 45° C. (113° F.) and a pressure of about 2.4 MPa(g) (350 psig) to about 3.5 MPa(g) (500 psig). Alternatively, the demethanizer bottoms temperature may be about-40° C. (−40° F.) to about 10° C. (50° F.) and a pressure of about 0.7 MPa(g) (102 psig) to about 2.1 MPa(g) (305 psig).

The net olefin rich stream in line 136 is deethanized by fractionation in the deethanizer column 140 to provide an ethylene stream in a net overhead line 161 and a fractionated olefin rich stream in a deethanized net bottoms line 142. The fractionated olefin rich stream may be considered a deethanized olefin rich stream. The deethanizer column 140 may be operated at a bottoms temperature of about 43° C. (110° F.) to about 104° C. (220° F.) and an overhead pressure of about 1.8 MPa(g) (260 psig) to about 3.2 MPa(g) (460 psig).

An ethylene overhead stream in an overhead line 141 may be heated by heat exchange with a concentrated ethylene stream in line 152. A heated ethylene overhead stream in line 146 is combined with a hydrogen stream from line 147 to provide a combined ethylene overhead stream in combine line 148, further heated in a heat exchanger 18 and a second heated combined ethylene overhead stream in line 149 is charged to an acetylene conversion reactor 150 comprising an acetylene conversion catalyst. The acetylene conversion catalyst in the acetylene conversion reactor 150 may be a palladium and silver on aluminum oxide catalyst. The acetylene conversion conditions in the acetylene conversion reactor 150 may include a pressure of about 1.4 MPa(g) (200 psig) to about 2.8 MPa(g) (400 psig) and a temperature of about 37° C. (100° F.) to about 93° C. (200° F.).

In the acetylene conversion reactor 150, acetylenes are converted to ethylene over the acetylene conversion catalyst in the presence of hydrogen thereby producing a concentrated ethylene stream in line 152. The concentrated ethylene stream in line 152 is condensed by heat exchange with the ethylene overhead stream in the overhead line 141 and a condensed concentrated ethylene stream in line 153 is further condensed by heat exchange in a heat exchanger 16. A second condensed concentrated ethylene stream in line 154 is separated in a deethanizer receiver 160 to provide the ethylene stream of vapor phase in the net overhead line 161 and a condensed liquid stream in a reflux line 162. Condensate from the deethanizer receiver 160 may be pumped using a pump 15 and refluxed back to the deethanizer column 140 in a pumped reflux line 163 from a bottom of the deethanizer receiver 160. The deethanized stream in the bottoms line 142 may be split between a reboil stream in line 143 which is reboiled in the reboiler 14 and a reboiled stream in line 145 is returned to the deethanizer column 140 to provide heating requirements.

The fractionated rich olefin stream in the net bottoms line 144 may contain oxygenates such as dimethyl ether and other oxygenates in concentration that would poison selective hydrogenation catalyst. Hence, the fractionated rich olefin stream in line 144 is routed to a water wash column 170 to absorb oxygenates from the fractionated rich olefin stream.

In the water wash column 170, a water wash stream from a DME wash water stripper column 155 is routed in an absorbent line 158 to a top third of the water wash column 170 and countercurrently contacted with the fractionated rich olefin stream in the net bottoms line 144 fed to a bottom third of the water wash column. Countercurrent contact of the fractionated rich olefin stream and the water wash stream effects absorption of the oxygenates including DME from the fractionated rich olefin stream into the water wash stream. Absorption produces a washed olefin stream in an overhead line 171 and an oxygenate rich water wash stream in a bottoms line 172. The washed olefin stream in the overhead line 171 has a total oxygenate concentration of no more than 1000 wppm which is acceptable for the selective hydrogenation catalyst in a selective hydrogenation reactor 180. Suitably, the washed olefin stream in the overhead line 171 has a total oxygenate concentration of no more than 500 wppm to moderate the adsorbent bed size required in an oxygenate removal unit 191. Preferably, the washed olefin stream in the overhead line 171 has a total oxygenate concentration of no more than 200 wppm. In a preferred embodiment, the washed olefin stream in the overhead line 171 has a total oxygenate concentration of less than 50 wppm. The water wash column 170 may be operated at a bottoms temperature of about 26° C. (50° F.) to about 66° C. (150° F.) and an overhead pressure of about 2.4 MPa(g) (350 psig) to about 3.2 MPa(g) (465 psig).

The oxygenate rich water wash stream in the bottoms line 172 is fed to the DME wash water stripper column 155 to be stripped of DME and other oxygenates. In the DME wash water stripper column 155, DME and oxygenates are stripped from the oxygenate rich water wash stream to produce a DME stream in line 156 which also contains other oxygenates which can be recycled to the oxygenate conversion reactor 110. A stripped water wash stream is produced in a bottoms line 157. A reboil stream in line 159 is taken from the stripped water wash stream in the bottoms line 157, reboiled in a reboiler 21 and transported back to the DME wash water stripper column 155. The water wash stream in the absorbent line 158 is taken from the stripped water wash stream in the bottoms line 157 and recycled to the water wash column 170 perhaps after supplementation with make-up water in line 151.

The washed olefin stream in line 171 may be oligomerized in an oligomerization reactor perhaps in liquid phase. However, the washed olefin stream in the water wash overhead line 171 comprising C3 to C6 olefins also contains diolefins that could cause cross-link polymerization in the oligomerization reactor. Therefore, it may be selectively hydrogenated to convert diolefins to mono-olefins. The washed olefin stream in the water wash overhead line 171 may be combined with a heavy olefin stream comprising C4+ olefins in line 174 to provide a combined olefin stream in a combined line 173. The combined olefin stream in the combined line 173 may be mixed with hydrogen from line 175 heated perhaps by heat exchange with the mono-olefin stream in line 182 in a heat exchanger 19 and charged to the selective hydrogenation reactor 180 in the selective hydrogenation charge line 176. In the selective hydrogenation reactor 180, diolefins and residual acetylenes are converted to mono-olefins to provide the mono-olefin stream in line 182. Selective hydrogenation effects just minimal hydrogenation of mono-olefins to paraffins.

The selective hydrogenation reactor 180 is normally operated at relatively mild hydrogenation conditions. These conditions will normally result in the hydrocarbons being present as liquid phase materials. The reactants will normally be maintained under the minimum pressure sufficient to maintain the reactants as liquid phase hydrocarbons. Suitable operating pressures include about 2.3 MPa(g) (330 psig) to about 3.1 MPa(g) (450 psig). A relatively moderate temperature between about 20° C. (68° F.) and about 100° C. (212° F.) is typically employed. The liquid hourly space velocity of the reactants through the selective hydrogenation catalyst should be above about 1.0 hr⁻¹ and about 35.0 hr⁻¹. To avoid the undesired saturation of a significant amount mono-olefinic hydrocarbons, the mole ratio of hydrogen to diolefinic hydrocarbons in the selective hydrogenation charge line 176 entering the bed of selective hydrogenation catalyst is maintained between 0.75:1 and 1.8:1.

Any suitable catalyst which is capable of selectively hydrogenating diolefins in a naphtha range stream may be used. Suitable catalysts include, but are not limited to, a catalyst comprising copper and at least one other metal such as titanium, vanadium, chrome, manganese, cobalt, nickel, zinc, molybdenum, palladium, and cadmium or mixtures thereof. The metals are preferably supported on inorganic oxide supports such as silica and alumina, for example. The mono-olefin stream may exit the reactor in line 182 with a greater concentration of ethylene and a smaller concentration of acetylenes and diolefins than in the selective hydrogenation charge stream in line 176. The mono-olefin stream in line 182 may comprise an acetylene and diolefin concentration of no more than about 50 to about 80 wppm.

The mono-olefin stream in line 182 may be oligomerized in a downstream oligomerization reactor perhaps in liquid phase. However, the mono-olefin stream still has a large concentration of oxygenates that could cause undesirable catalyst deactivation in the oligomerization reactor. Accordingly, the mono-olefin stream in line 182 may be transported to an oxygenate removal unit 191 to adsorb residual oxygenates including DME and water. The mono-olefin stream in line 182 is heat exchanged with the combined olefin stream in line 173 in the heat exchanger 19 and a heated mono-olefin stream in line 183 is passed to the oxygenate removal unit 191. The oxygenate removal unit 191 may comprise one or more adsorbent vessels 190, 194, so one adsorbent vessel 190 or 194 can be charged with the heated mono-olefin stream in line 183 by appropriate valve control to adsorb oxygenates therefrom while the other adsorbent vessel 190 or 194 can be fed with a regenerant stream from line 186 by appropriate valve control to undergo regeneration. In an embodiment, the heated mono-olefin stream in line 183 is split into a first mono-olefin stream in line 184 and a second mono-olefin stream in line 185. The first mono-olefin stream in line 184 is charged to a first adsorbent vessel 190 and the second mono-olefin stream in line 185 is charged to a second adsorbent vessel 194.

The heated mono-olefin stream in line 183 may flow upwardly in the adsorbent vessel 190 or 194 but downstream is also suitable. Three adsorbent vessels may be used in the oxygenate removal unit 191 to ensure that one adsorbent vessel is always operating in adsorption mode. A first deoxygenated olefin stream in line 198 may be recovered from the first adsorbent vessel 190 and a second deoxygenated olefin stream in line 199 may be recovered from the second adsorbent vessel 194. The first deoxygenated olefin stream in line 198 and the second deoxygenated olefin stream in line 199 may be combined to provide a combined deoxygenated olefin stream in line 196. The combined deoxygenated olefin stream in line 196 comprises C3 to C6 olefins and not more than 1 wppm oxygenate including DME and water.

A first oxygenated regenerant stream in line 192 may be recovered from the first adsorbent vessel 190 and a second oxygenated regenerant stream in line 195 may be recovered from the second adsorbent vessel 194. The first oxygenated regenerant stream in line 192 and the second oxygenated regenerant stream in line 195 may be combined to provide a combined oxygenated regenerant stream in line 197.

When the first adsorbent vessel 190 or the second adsorbent vessel 194 requires regeneration, it can be taken off-stream with the heated mono-olefin stream in line 183 and contacted with a heated vaporous regenerant from line 186 through appropriate valve control in a direction counter to the normal flow of the olefinic selectively hydrogenated stream. The regenerant may be a clean inert gas such as nitrogen, hydrogen, natural gas and light paraffins such as propane, butanes and pentanes. The regenerant can fully restore the capacity of the adsorbent in the first adsorbent vessel 190 and the second adsorbent vessel 194. The spent regenerant can leave the oxygenate removal unit 191 in a combined spent regenerant line 197. The oxygenate removal unit 191 may be operated at an inlet temperature of about 26° C. (50° F.) to about 66° C. (150° F.) and an inlet pressure of about 2.3 MPa(g) (330 psig) to about 3 MPa(g) (435 psig). The adsorbent in the oxygenate removal unit 191 may be a large pore molecular sieve such as 13× molecular sieve.

The combined deoxygenated olefin stream in line 196 may provide an oligomerization charge stream that can be charged to the downstream oligomerization reactor. Also, the ethylene stream in the net overhead line 161 may be charged to the downstream oligomerization reactor.

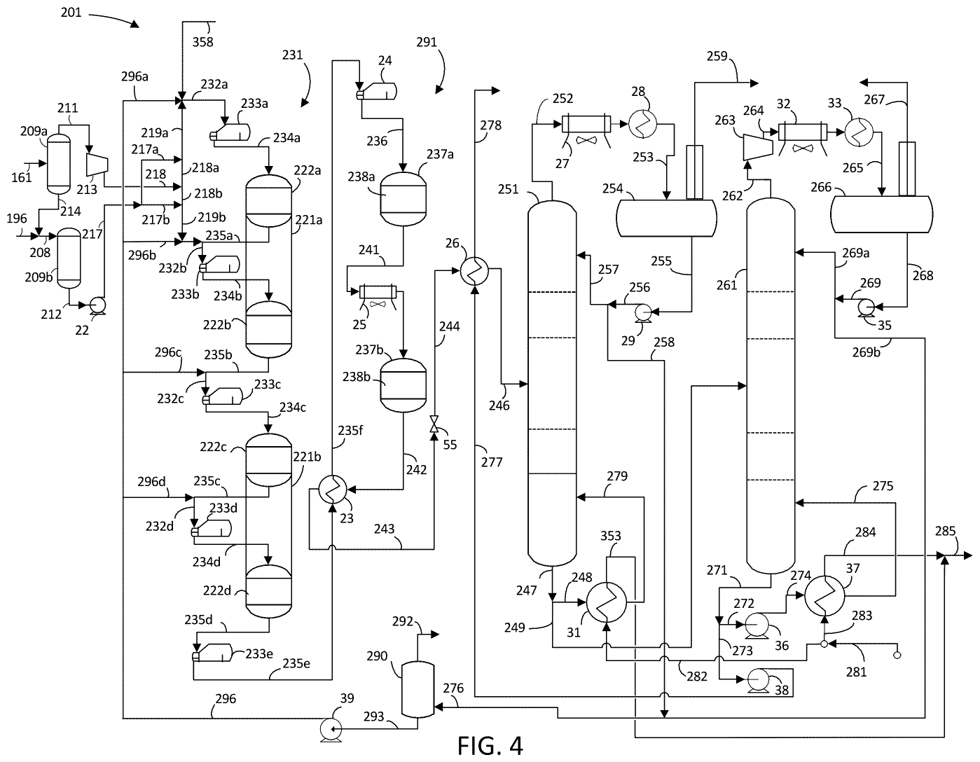

The oligomerization section 201 is illustrated in FIG. 4. A charge olefin stream and a recycle olefin stream are oligomerized with a first-stage oligomerization catalyst to produce a first-stage oligomerized olefin stream. The first-stage oligomerized olefin stream is oligomerized with a second-stage oligomerization catalyst to provide a second-stage oligomerized stream. A dealkanizer column can be used to remove light alkanes that would be inert and accumulate in a recycle loop. The second-stage oligomer product stream is hydrogenated to produce fuels

Turning to the oligomerization section 201 of FIG. 4, the ethylene stream in the net overhead line 161 comprising C2 olefins from FIG. 3 is fed to a preliminary separator 209a. The ethylene stream in the net overhead line 161 is separated in the preliminary separator 209a to provide a vapor olefin stream in line 211 and a liquefied olefin stream in line 214. The preliminary separator may be operated at a temperature of about 16° C. (60° F.) to about 38° C. (100° F.) and a pressure of about 2.1 MPa(g) (300 psig) to about 2.8 MPa(g) (400 psig). The vapor olefin stream in line 211 may be compressed in a compressor 213 up to oligomerization pressure in line 218.

The combined deoxygenated olefin stream in line 196 is provided to the oligomerization section 201. The combined deoxygenated olefin stream in line 196 may comprise C3-C8 olefins. The combined deoxygenated olefin stream in line 196 may be combined with the liquefied olefin stream in line 214 which may comprise C3-C8 olefins and a combined liquefied olefin stream in line 208 is fed to a liquid feed surge drum 209b. A liquid olefin stream in line 212 from the liquid feed surge drum 209b comprising C3-C8 liquid olefins is pumped via a pump 22 and a pumped liquid olefin stream in line 217 is passed to the oligomerization reactor. In an aspect, the pumped liquid olefin stream in line 217 may be combined with a compressed vapor olefin stream in line 218 and passed to the oligomerization reactor.

The compressed vapor olefin stream in line 218 and the liquid olefin stream in line 217 may comprise substantial ethylene and propylene. The vapor and liquid olefin streams may predominantly comprise ethylene and/or propylene. In an aspect, the vapor and liquid olefin streams may comprise at least 95 mol % ethylene and/or propylene. The compressed vapor olefin stream in line 218 and the liquid olefin stream in line 217 may be styled light olefin streams. Additional olefinic species with carbon numbers ranging from C4 to C8 can be expected in the charge streams. The light olefin streams may be at a temperature of about 20° C. (68° F.) to about 150° C. (302° F.) and a pressure of about 2.16 MPag (350 psig), preferably about 3.5 MPag (500 psig), to about 8.4 MPag (1200 psig).

The light olefin streams may be initially contacted with a first-stage oligomerization catalyst to oligomerize the ethylene and propylene to oligomers and then contacted with a second oligomerization catalyst to oligomerize unconverted ethylene and propylene from the first-stage oligomerization.

The oligomerization reaction generates a large exotherm. For example, dimerization of ethylene can generate 612 kcal/kg (1100 BTU/lb) of heat. Consequently, this large exotherm must be managed. Accordingly, the compressed vapor olefin stream in line 218 and the liquid olefin stream in line 217 may each be split into multiple olefin streams. In FIG. 4, compressed vapor olefin stream in line 218 and the liquid olefin stream in line 217 are each split into two separate streams. The compressed vapor olefin stream in line 218 may be split into a first vapor olefin stream in line 218a and a second vapor olefin stream in 218b. The liquid olefin stream in line 217 is split into a first liquid olefin stream in line 217a and a second liquid olefin stream in line 217b. The first vapor olefin stream in line 218a is mixed with the first liquid olefin stream in line 217a to provide a first charge olefin stream in a first charge olefin line 219a. The second vapor olefin stream in line 218b is mixed with the second liquid olefin stream in line 217b to provide the second charge olefin stream in a second charge olefin line 219b. More or less separate multiple olefin streams may be used. Up to six charge olefin streams are readily contemplated.

The compressed vapor olefin stream in line 218 may be split into equal aliquot multiple olefin streams in lines 218a and 218b. The liquid olefin stream in line 217 may be split into equal aliquot multiple olefin streams in lines 217a and 217b. Alternatively, the compressed vapor olefin stream in line 218 may be split into unequal streams. Similarly, the liquid olefin stream in line 217 may be split into unequal streams. For example, either or both of the vapor olefin stream or the liquid olefin stream may be split into streams of descending flow rates in which a charge olefin stream to a preceding reactor has a larger flow rate than a charge olefin stream to a subsequent reactor. In an embodiment, both of the vapor olefin stream or the liquid olefin stream may be split into two streams of equal flow rates, each comprising 50 vol % of the charge olefin stream.

In another embodiment, the first charge olefin stream in the first charge olefin line 219a may comprise about 70 to about 90 vol % of the charge olefin streams and the second charge olefin streams in the second olefin line 219b may comprise about 10 to about 30 vol % of the charge olefin streams. In another embodiment, each of the charge streams are split in different proportions. For example, the liquid olefin stream in line 217 can be split into two streams such that the first liquid stream in line 217a would comprise 70 to 90% of the liquid olefin stream in line 217 and the second liquid stream in line 217b would comprise of 10 to 30% of the liquid olefin stream 217, while compressed vapor stream in line 218 would be split equally into two streams such that both the first vapor olefin stream in line 218a and the second olefin stream in line 218b comprise of 50% of the compressed vapor olefin stream.

To manage the exotherm, the charge olefin stream may be diluted with a diluent stream to provide a diluted olefin stream to absorb the exotherm. The diluent stream may comprise a paraffin stream in a diluent line 358. The diluent stream in the diluent line 358 may be added to the first charge olefin stream in the first charge olefin line 219a before they are charged to the first-stage oligomerization reactor 231. Preferably, the diluent stream is added to the first charge olefin stream in line 219a after the splits of the charge olefin streams in line 218 and 217 into multiple olefin streams to provide a first diluted olefin charge stream in line 232a, so the diluent stream passes through all of the first-stage oligomerization reactions.

Alternatively, the diluent stream may also be split into multiple streams with each diluent stream added to one or more of a corresponding charge olefin stream. The diluent stream may have a mass flow rate of about 2 to about 8 times and preferably about 3 to about 6 times the combined mass flow rates of the first charge olefin stream in the first charge olefin line 219a and the second charge olefin stream in the second charge olefin line 219b.

A recycle olefin stream in a recycle line 296 comprising C4 to C8 olefins may be mixed with the charge olefin stream and oligomerized in the first-stage oligomerization reactor 231. In an embodiment, the recycle olefin stream in line 296 is split into a plurality of recycle olefin streams 296a, 296b, 296c, and 296d. A recycle olefin stream in a first recycle olefin line 296a may be mixed with the first charge olefin stream in line 219a and charged to the first-stage oligomerization reactor 231. In a further embodiment, the first recycle olefin stream in the first recycle olefin line 296a is mixed with the first charge olefin stream in line 219a and the diluent stream in line 358 to provide a diluted first charge olefin stream in line 232a.

The first diluted charge olefin stream may comprise no more than 50 wt % olefins, suitably no more than 30 wt % olefins and preferably no more than 20 wt % olefins. In an embodiment, the first diluted olefin stream comprises about 10 to about 35 wt % C2 to C8 olefins. The first diluted olefin stream may comprise no more than 50 wt % ethylene, suitably no more than 25 wt % ethylene and preferably no more than 20 wt % ethylene. In an embodiment, the first diluted charge olefin stream comprises about 10 to about 20 wt % propylene. The first diluted charge olefin stream may comprise no more than 50 wt % propylene, suitably no more than 25 wt % propylene and preferably no more than 20 wt % propylene. In an embodiment, the first diluted charge olefin stream comprises about 10 to about 20 wt % propylene.

The first-stage oligomerization reactor 231 may comprise a series of first-stage oligomerization catalyst beds 222a, 222b, 222c and 222d each for charging with olefin charge streams. The first-stage oligomerization 231 reactor preferably contains four fixed first-stage oligomerization catalyst beds 222a, 222b, 222c and 222d. It is also contemplated that each first-stage oligomerization catalyst bed 222a, 222b, 222c and 222d may be in a dedicated first-stage oligomerization reactor or multiple first-stage oligomerization catalyst beds may be in two or more separate first-stage oligomerization reactor vessels. Up to six, first-stage oligomerization catalyst beds are readily contemplated. In FIG. 4, two, first stage oligomerization reactor vessels 221a and 221b are utilized.

A parallel first-stage oligomerization reactor may be used when the first-stage oligomerization reactor 231 has deactivated during which the first-stage oligomerization reactor 231 is regenerated in situ by combustion of coke from the catalyst. In another embodiment, each first-stage oligomerization reactor may comprise a lead reactor, a lag reactor and a spare reactor to facilitate regeneration. Only two reactor vessels 221a, and 221b are shown in FIG. 4.

The diluted first charge olefin stream in line 232a may be cooled in a first charge cooler 233a to provide a cooled diluted first charge olefin stream in line 234a and charged to a first bed 222a of first-stage oligomerization catalyst in the first, first-stage oligomerization reactor vessel 221a of the first-stage oligomerization reactor 231. The cooled diluted first charge olefin stream in line 234a may be charged at a temperature of about 180° C. (356° F.) to about 260° C. (500° F.) and a pressure of about 3.5 MPag (500 psig) to about 8.4 MPag (1200 psig). The charge cooler 233a may comprise a steam generator.

The diluted first charge olefin stream may be charged to the first, first-stage catalyst bed 222a in line 233a preferably in a down flow operation. However, upflow operation may be suitable. The diluted first charge olefin stream is in a mixed vapor-liquid phase in which the vapor phase predominantly comprises ethylene. As oligomerization of ethylene, propylene and recycle olefins occurs in the first, first-stage oligomerization catalyst bed 222a, an exotherm is generated due to the highly exothermic nature of the olefin oligomerization reaction. Oligomerization of the first charge olefin stream produces a first oligomerized effluent stream in a first oligomerized effluent line 235a at an elevated outlet temperature despite the cooling and dilution. The elevated outlet temperature is limited to between 150° C. (302° F.) and about 260° C. (500° F.).

The second charge olefin stream in line 219b may be mixed with a second recycle olefin stream in a second recycle olefin line 296b and with the first oligomerized effluent stream in the first oligomerized effluent line 235a removed from the first, first-stage oligomerization catalyst bed 222a in the first, first-stage reactor 221a to provide a mixed second charge olefin stream in line 232b. The first oligomerized effluent stream in line 235a includes the diluent stream from diluent line 358 added to the first charge olefin stream in line 219a. The second charge olefin stream in line 219b may comprise no more than 35 wt % C2 to C8 olefins, suitably no more than 25 wt % C2 to C8 olefins and preferably no more than 20 wt % C2 to C8 olefins. The second charge olefin stream in line 219b may comprise no more than 30 wt % ethylene, suitably no more than 25 wt % ethylene and preferably no more than 20 wt % ethylene. The second charge olefin stream in line 219b may comprise no more than 30 wt % propylene, suitably no more than 25 wt % propylene and preferably no more than 20 wt % propylene. The second mixed charge olefin stream in line 219b may be cooled in a second charge cooler 233b which may be located externally to the first, first-stage oligomerization reactor 221a to provide a cooled second charge olefin stream in line 234b and charged to a second bed 222b of first-stage oligomerization catalyst in the first, first-stage oligomerization reactor 221a. The charge cooler 233b may comprise a steam generator.

The second cooled charge olefin stream in line 234b may be charged at a temperature of about 180° C. (356° F.) to about 230° C. (446° F.) and a pressure of about 3.5 MPag (500 psig) to about 8.4 MPag (1200 psig). The second cooled charge olefin stream will include diluent and olefins from the first oligomerized stream. The diluted second charge olefin stream is in a mixed vapor-liquid phase in which the vapor phase predominantly comprises ethylene. The olefins from the first oligomerized stream will oligomerize in the second, first-stage catalyst bed 222b. Oligomerization of ethylene, propylene, recycle olefins and oligomers in the second olefin stream in the second, first-stage oligomerization catalyst bed 222b produces a second oligomerized olefin effluent stream in a second oligomerized effluent line 235b at an elevated outlet temperature. The elevated outlet temperature may be limited to between 30° C. (54° F.) and about 50° C. (90° F.) above the inlet temperature to the catalyst bed 222b.

The second oligomerized effluent stream in line 235b removed from the second, first-stage oligomerization catalyst bed 222b in the first, first-stage reactor vessel 221a may be mixed with a third recycle olefin stream in a third recycle olefin line 296c to provide a first recycle olefin charge stream in line 232c. In an embodiment, none of the first charge olefin stream in line 219a and the second charge olefin stream in line 219b is directly added to the first recycle olefin charge stream in line 232c. Alternatively, a portion of the charge olefin streams in lines 219a and 219b may be charged with the second oligomerized effluent stream with the first recycle olefin charge stream in line 232c. The second oligomerized effluent stream in line 235b includes the diluent stream from diluent line 358 added to the first charge olefin streams in line 219a. The first recycle olefin charge stream in line 232c may comprise no more than 30 wt % ethylene, suitably no more than 25 wt % ethylene and preferably no more than 20 wt % ethylene. The first recycle olefin charge stream may comprise no more than 30 wt % propylene, suitably no more than 25 wt % propylene and preferably no more than 20 wt % propylene. The first recycle olefin charge stream in line 232c may comprise no more than 30 wt % C2 to C8 olefins, suitably no more than 25 wt % C2 to C8 olefins and preferably no more than 20 wt % C2 to C8 olefins. The first recycle olefin charge stream in line 232c may be cooled in a third charge cooler 233c which may be located externally to the oligomerization reactor 231 to provide a cooled first recycle olefin charge stream in line 234c and charged to a third bed 222c of first-stage oligomerization catalyst in the first-stage oligomerization reactor 231. In an embodiment, the third bed 222c of first-stage oligomerization catalyst is provided in a second, first-stage oligomerization reactor vessel 221b. The charge cooler 233c may comprise a steam generator.

The cooled first recycle olefin charge stream in line 234c may be charged at a temperature of about 180° C. (356° F.) to about 230° C. (446° F.) and a pressure of about 3.5 MPag (500 psig) to about 8.4 MPag (1200 psig). The first recycle olefin charge stream will include diluent and olefins from the second oligomerized olefin stream and the third recycle olefin stream. The olefins will oligomerize in the third catalyst bed 222c. Oligomerization of ethylene and propylene and oligomerization of oligomers in the first recycle olefin charge stream in the third bed 222c of first-stage oligomerization catalyst produces a third oligomerized effluent stream in a third oligomerized effluent line 235c at an elevated outlet temperature. In an embodiment, the third oligomerized effluent stream is a penultimate oligomerized effluent stream and the third oligomerized effluent line 235c is a penultimate oligomerized effluent line 2235c. The elevated outlet temperature is limited to between 30° C. (54° F.) and about 50° C. (90° F.) above the inlet temperature to the catalyst bed 222c.

The third oligomerized effluent stream in line 235c removed from the second, first-stage oligomerization reactor vessel 221b of the first-stage oligomerization reactor 231 may be mixed with the fourth recycle olefin stream in line 296d to provide a second recycle olefin charge stream in line 232d. The third oligomerized effluent stream in line 235c includes the diluent stream from diluent line 358 added to the first olefin stream in line 219a. None of the charge olefin streams in lines 219a and 219b is directly added to the second recycle olefin charge stream in line 232d. In an embodiment, the third oligomerized effluent stream in line 235c may also be mixed with a portion of the charge olefin streams in lines 219a and 219b and be oligomerized therewith. The second recycle olefin charge stream in line 232d may comprise no more than 35 wt % C2 to C8 olefins, suitably no more than 30 wt % C2 to C8 olefins and preferably no more than 25 wt % C2 to C8 olefins. The second recycle olefin charge stream may comprise no more than 30 wt % ethylene, suitably no more than 25 wt % ethylene and preferably no more than 20 wt % ethylene. The second recycle olefin charge stream may comprise no more than 30 wt % propylene, suitably no more than 25 wt % propylene and preferably no more than 20 wt % propylene. The second recycle olefin charge stream in line 232d may be cooled in a fourth charge cooler 233d which may be located externally to the second vessel 221b of the first-stage oligomerization reactor 231 to provide a cooled second recycle olefin charge stream in line 234d and charged to a fourth bed 222d of first-stage oligomerization catalyst in the second vessel of the first-stage oligomerization reactor 231. The charge cooler 233d may comprise a steam generator.

The cooled second recycle olefin charge stream in line 234d may be charged at a temperature of about 180° C. (356° F.) to about 230° C. (446° F.) and a pressure of about 3.5 MPa(g) (500 psig) to about 8.4 MPa(g) (1200 psig). The cooled second recycle olefin charge stream in line 234d will include diluent and olefins from the third or penultimate oligomerized effluent stream and C4-C8 olefins from the fourth recycle olefin stream. The olefins will oligomerize over the fourth catalyst bed 222d. Oligomerization of ethylene and propylene in the second recycle olefin charge stream in the fourth bed 222d of first-stage oligomerization catalyst produces a fourth oligomerized stream in a fourth oligomerized effluent line 235d at an elevated outlet temperature. The elevated outlet temperature is limited to between 30° C. (54° F.) and about 50° C. (90° F.) above the inlet temperature to the catalyst bed 222d.

The fourth oligomerized effluent stream in line 235d exits the second reactor vessel 221b of the first-stage oligomerization reactor 231. In an embodiment, the fourth oligomerized effluent stream in line 235d is a last oligomerized effluent stream, and the fourth oligomerized effluent line 235d is a last oligomerized effluent line 235d.

The first-stage oligomerization reaction takes place predominantly in the liquid phase or in a mixed liquid and gas phase at a WHSV of 0.5 to 10 hr⁻¹ on an olefin basis. The ethylene will initially dimerize over the catalyst to butenes. A predominance of the propylene and butenes in the olefins stream charged to a first-stage oligomerization catalyst bed is oligomerized.

The first-stage oligomerization catalyst may include a zeolitic catalyst. The first-stage oligomerization catalyst may be considered a solid acid catalyst. The zeolite may comprise between about 5 and about 95 wt % of the catalyst, for example between about 5 and about 85 wt %. Suitable zeolites include zeolites having a structure from one of the following classes: MFI, MEL, ITH, IMF, TUN, FER, BEA, FAU, BPH, MEI, MSE, MWW, UZM-8, MOR, OFF, MTW, TON, MTT, AFO, ATO, and AEL. Three-letter codes indicating a zeotype are as defined by the Structure Commission of the International Zeolite Association and are maintained at http://www.iza-structure.org/databases. UZM-8 is as described in U.S. Pat. No. 6,756,030. In a preferred aspect, the first-stage oligomerization catalyst may comprise a zeolite with a framework having a ten-ring pore structure. Examples of suitable zeolites having a ten-ring pore structure include TON, MTT, MFI, MEL, AFO, AEL, EUO and FER. In a further preferred aspect, the first-stage oligomerization catalyst comprising a zeolite having a ten-ring pore structure may comprise a uni-dimensional pore structure. A uni-dimensional pore structure indicates zeolites containing non-intersecting pores that are substantially parallel to one of the axes of the crystal. The pores preferably extend through the zeolite crystal. Suitable examples of zeolites having a ten-ring uni-dimensional pore structure may include MTT. In a further aspect, the first-stage oligomerization catalyst comprises an MTT zeolite.

In one exemplary embodiment, an MTT-type zeolite catalyst disposed on a high purity pseudo boehmite alumina substrate in a ratio of about 90/10 to about 20/80 and preferably between about 20/80 and about 50/50 is provided in a catalyst bed or more in the first-stage oligomerization reactor 231.

The first-stage oligomerization catalyst can be regenerated upon deactivation. Suitable regeneration conditions include subjecting the first-stage oligomerization catalyst, for example, in situ, to hot air at about 400 to about 500° C. To facilitate regeneration without downtime, a swing bed arrangement may be employed with an alternative first-stage oligomerization reactor. A regeneration gas stream may be admitted to the first-stage oligomerization reactor 231 requiring regeneration. The regeneration gas may comprise air with an increased or decreased concentration of oxygen. Activity and selectivity of the regenerated catalyst is comparable to fresh catalyst.

The zeolite catalyst is advantageous as a first-stage oligomerization catalyst. The zeolitic catalyst has relatively low sensitivity towards oxygenates contamination. Consequently, a smaller degree of removal of oxygenates is required of olefinic feed in line 1 if produced from an alcohol dehydration process.

The last first-stage oligomerized stream in the last first-stage oligomerized effluent line 235d has an increased concentration of ethylene and propylene oligomers compared to the light olefin streams in lines 217 and 218. The last first-stage oligomerized stream in the last first-stage oligomerized effluent line 235d is cooled by steam generation in a steam generator 233e or by other heat exchange to provide a cooled last first-stage oligomerized stream in line 235e. The cooled last first-stage oligomerized stream in line 235e may be further cooled by heat exchange with a second stage oligomerized stream in line 242. A second cooled last first-stage oligomerized stream in line 235f is perhaps further cooled such as by a steam generator 24 to provide a charge first-stage oligomerized stream and charged to a second-stage oligomerization reactor 291 in a second-stage oligomerization charge line 236. To achieve the most desirable olefin product, the second-stage oligomerization reactor 291 is operated at a temperature from about 80° C. (176° F.) to about 200° C. (392° F.). The second-stage oligomerization reactor 291 is run at a pressure from about 2.1 MPa (300 psig) to about 7.6 MPa (1100 psig), and more preferably from about 3.5 MPa (500 psig) to about 6.9 MPa (1000 psig). The second-stage oligomerization charge stream oligomerizes in a mixed vapor-liquid phase to predominantly C4+ olefins.

The second-stage oligomerization reactor 291 may be in downstream communication with the first-stage oligomerization reactor 231. The second-stage oligomerization reactor 291 preferably operates in a down flow operation. However, upflow operation may be suitable. The second-stage oligomerization charge stream is contacted with the second-stage oligomerization catalyst causing the unconverted ethylene from the first-stage oligomerization reactor 231 to dimerize and trimerize while higher olefins also dimerize, trimerize and tetramerize to provide distillate range olefins. With regard to the second-stage oligomerization reactor 291, process conditions may be selected to produce a higher percentage of jet range olefins which, when hydrogenated in a subsequent step as will be described below, result in a desirable jet-range hydrocarbon product. The predominance of the unconverted ethylene from the first-stage oligomerization reactor 231 is dimerized, trimerized and tetramerized. In an embodiment, at least 99 wt % of ethylene in the second-stage oligomerization charge stream is converted to mostly butenes.

The second-stage oligomerization reactor 291 may comprise a first reactor vessel 237a comprising a first bed 238a of second-stage oligomerization catalyst and a second reactor vessel 237b comprising a second bed 238b of second-stage oligomerization catalyst. A first, second-stage oligomerized stream is discharged from the first, second-stage reactor vessel 237a, cooled and charged to the second, second-stage reactor vessel 237b. A second-stage oligomerized stream with an increased average carbon number greater than the charge second-stage oligomerized stream in line 242 exits the second-stage oligomerization reactor 291 in line 242.

The first-stage oligomerization reactor 231 and the second-stage oligomerization reactor 291 may utilize vapor-liquid distribution trays to mix and disperse the ethylene vapor with liquid olefin and liquid paraffin to promote heat transfer and manage the exotherm.

The second-stage oligomerization catalyst is preferably an amorphous silica-alumina base with a metal from either Group VIII and/or Group VIB in the periodic table using Chemical Abstracts Service notations. In an aspect, the catalyst has a Group VIII metal promoted with a Group VIB metal. Typically, the silica and alumina will only be in the base, so the silica-to-alumina ratio will be the same for the catalyst as for the base. The metals can either be impregnated onto or ion exchanged with the silica-alumina base. Co-mulling is also contemplated. Catalysts for the present invention may have a Low Temperature Acidity Ratio of at least about 0.15, suitably of about 0.2, and preferably greater than about 0.25, as determined by Ammonia Temperature Programmed Desorption (Ammonia TPD) as described hereinafter. Additionally, a suitable catalyst will have a surface area of between about 50 and about 400 m²/g as determined by nitrogen BET.

The preferred second-stage oligomerization catalyst comprises an amorphous silica-alumina support. One of the components of the catalyst support is alumina. The alumina may be any of the various hydrous aluminum oxides or alumina gels such as alpha-alumina monohydrate of the boehmite or pseudo-boehmite structure, alpha-alumina trihydrate of the gibbsite structure, beta-alumina trihydrate of the bayerite structure, and the like. A particularly preferred alumina is available from Sasol North America Alumina Product Group under the trademark CATAPAL. This material is an extremely high purity alpha-alumina monohydrate (pseudo-boehmite) which after calcination at a high temperature has been shown to yield a high purity gamma-alumina. Another component of the catalyst support is an amorphous silica-alumina. A suitable silica-alumina with a silica-to-alumina ratio of 2.6 is available from CCIC, a subsidiary of JGC, Japan.

Another component of the second-stage oligomerization catalyst is a surfactant. The surfactant is preferably admixed with the hereinabove described alumina and the silica-alumina powders. The resulting admixture of surfactant, alumina and silica-alumina is then formed, dried and calcined. The calcination effectively removes by combustion the organic components of the surfactant but only after the surfactant has dutifully performed its function in accordance with the present invention. Any suitable surfactant may be utilized in accordance with the present invention. A preferred surfactant is a surfactant selected from a series of commercial surfactants sold under the trademark “Antarox” by Solvay S.A. The “Antarox” surfactants are generally characterized as modified linear aliphatic polyethers and are low-foaming biodegradable detergents and wetting agents.

A preferred second-stage oligomerization catalyst has an amorphous silica-alumina base impregnated with about 0.5 to about 15 wt-% nickel in the form of 3.175 mm (0.125 inch) extrudates and a density of about 0.45 to about 0.65 g/ml. It is also contemplated that metals can be incorporated onto the support by other methods such as ion-exchange and co-mulling.

The second-stage oligomerization catalyst can be regenerated upon deactivation. Suitable regeneration conditions include subjecting the catalyst, for example, in situ, to hot air at about 400 to about 500° C. To facilitate regeneration without downtime, a swing bed arrangement may be employed with an alternative second-stage oligomerization reactor. The regeneration gas may comprise air with an increased or decreased concentration of oxygen. Activity and selectivity of the regenerated catalyst is comparable to fresh catalyst.

Second-stage oligomerization reactions are also exothermic in nature. The last oligomerized olefin stream in line 235d includes the diluent stream from diluent line 358 added to the first charge olefin stream in the first charge olefin line 219a and carried through the first-stage oligomerization catalyst beds 222a, 222b, 222c, and 222d. The diluent stream is then transported into the second-stage oligomerization reactor 291 in the second-stage oligomerization charge line 236 to absorb the exotherm in the second-stage oligomerization reactor 291. A dedicated diluent line to the second-stage oligomerization reactor 291 is also contemplated for prompt control of exotherm rise or to cool down the second-stage oligomerization reactor 291.

When the oligomerization reaction is performed according to the above-noted process conditions, a C4 olefin conversion of greater than or equal to about 95% is achieved, or greater than or equal to 97%. The resulting second-stage oligomerized stream in line 242 includes a plurality of olefin products that are distillate range hydrocarbons. The oligomerized olefin stream in line 242 is at a temperature from about 160° C. (320° F.) to about 190° C. (374° F.) and a pressure of about 3.9 MPa (gauge) (550 psig) to about 7 MPa (gauge) (1000 psig).

An oligomerized olefin stream in line 242 with an increased C8+ olefin concentration compared to the charge second-stage oligomerization stream in line 236 is heat exchanged with the cooled last first-stage oligomerized stream in line 235e. A heated oligomerized olefin stream in line 243 is let down in pressure by passing through an expansion valve 55. An expanded oligomerized olefin stream in line 244 is subsequently heat exchanged with an olefin splitter bottoms stream in line 277 in a heat exchanger 26. A heat exchanged perhaps heated oligomerized olefin stream in line 246 is fed to a dealkanizer column 251. In an exemplary embodiment, the dealkanizer column 251 is a dealkanizer column.

In the dealkanizer column 251, light alkanes such as C3− and suitably C2− hydrocarbons, are separated perhaps in a light alkane overhead stream in an overhead line 252 from perhaps a dealkanized bottoms stream in a bottoms line 247 comprising C4+ and suitably C3+ hydrocarbons. Olefins may be recycled to the first-stage oligomerization reaction 231 from the dealkanizer overhead stream in the overhead line 252. The dealkanizer column 251 may be operated at a bottoms temperature of about 177° C. (350° F.) to about 302° C. (575° F.) and an overhead pressure of about 207 kPa (gauge) (30 psig) to about 690 kPa (gauge) (100 psig) if operated as a deethanizer column. The dealkanizer column 251 may be operated at a bottoms temperature of about 194° C. (381° F.) to about 333° C. (630° F.) and an overhead pressure of about 207 kPa (gauge) (30 psig) to about 1.38 MPa (gauge) (200 psig) if operated as a dealkanizer column.

The light alkane overhead stream in the overhead line 252 may be cooled in an air cooler 27, condensed in a condenser 28, and a cooled-condensed light alkane overhead stream in line 253 is separated in a dealkanizer receiver 254 to provide a dealkanized off-gas stream in an off-gas line 259 in which it may be chilled and fed to further processing such as to be taken as fuel gas for further processing in FIG. 1 and/or FIG. 2.

In an aspect, off-gas from the dealkanizer column 251 is passed to the reforming section 205 in FIG. 1 and/or FIG. 2. In an embodiment, the dealkanized off-gas stream in the off-gas line 259 may be taken in the off-gas line 202 and passed to the pre-reforming reactor 205 in FIG. 1 or the partial oxidation reactor 207 of FIG. 2.

Condensate from the dealkanizer receiver 254 may be refluxed back to the dealkanizer column 251 in a dealkanizer overhead liquid line 255. The condensate stream in line 255 may be pumped using a pump 29 and a pumped condensate stream in line 256 may be refluxed back to the dealkanizer column 251. In an embodiment, a reflux stream is taken in a reflux line 257 from the pumped condensate stream in line 256 and refluxed to the dealkanizer column 251. In another embodiment, an olefin recycle stream is taken in line 258 from the pumped condensate stream and recycled to the first stage oligomerization reactor 231.

The dealkanized stream perhaps in the bottoms line 247 may be split to provide a reboil stream in line 248 which is reboiled by heat exchange with a first hot diesel stream in line 282 perhaps taken from a jet fractionator bottom heat exchange stream in the jet bottoms heat exchange line 281. A reboiled stream in line 279 is passed to the dealkanizer column 251 to provide heating requirements. A net bottoms stream is taken in line 249 and fed directly to an olefin splitter column 261 perhaps without heating.

The dealkanized stream in the dealkanizer net bottoms line 249 is split by fractionation in the olefin splitter column 261 into a light olefin stream perhaps in an olefin splitter overhead line 262 and a heavy olefin stream perhaps in an olefin splitter bottoms line 271. Olefins may be recycled to the first-stage oligomerization reaction 231 from the olefin splitter overhead stream in the overhead splitter overhead line 262. The olefin splitter overhead stream in line 262 is expanded in an expander 263, and an expanded olefin splitter overhead stream in line 264 is cooled in a cooler 32, condensed in a condenser 33 and a condensed olefin splitter overhead stream in line 265 is passed to an olefin splitter receiver 266. The olefin splitter overhead stream may be chilled to about 19° C. (66° F.) to about 93° C. (200° F.) and a resulting condensate portion is refluxed from the olefin splitter receiver 266 back to the olefin splitter column 261. The net vapor stream in the receiver overhead line 267 from the olefin splitter receiver 266 may be charged to the pre-reforming reactor 205 in FIG. 1 or the partial oxidation reactor 207 of FIG. 2.

In an exemplary embodiment, the net vapor stream in the receiver overhead line 267 may be combined with the dealkanized off-gas stream in the off-gas line 259 to provide a combined off-gas stream which is passed to the pre-reforming section 205 in FIG. 1 or the partial oxidation reactor 207 of FIG. 2.

The light olefin condensate from a bottom of the olefin splitter receiver in line 268 may be refluxed back to the olefin splitter column 261. The light olefin condensate stream in line 268 may be pumped using a pump 35 and a pumped light olefin condensate stream in line 269 may be refluxed back to the olefin splitter column 261. In an embodiment, a reflux stream is taken in a reflux line 269a from the pumped light olefin condensate stream in line 269 and refluxed to the olefin splitter column 261. In another embodiment, a light olefin recycle stream is taken in line 269b from the pumped light olefin condensate stream and recycled to the first stage oligomerization reactor 231 or alternatively to the second-stage oligomerization reactor 291. The light olefin recycle stream in line 269b may comprise about 1 to about 15 wt % or perhaps a predominance of the light olefin stream in line 268. The light olefin recycle stream in line 269b may comprise about 40 to about 80 wt % C4-C8 olefins. In an embodiment, the light olefin recycle stream in line 269b may be combined with the olefin recycle stream in line 258 to provide a combined olefin recycle stream in line 276. The combined olefin recycle stream in line 276 is flashed in a knock-out drum 290 to remove vapors in a light olefin vapor stream in an overhead line 292 and a liquid recycle olefin oligomer stream in line 293 may be recycled to the first-stage oligomerization reactor 231 to oligomerize the C4-C8 olefins. The liquid recycle olefin oligomer stream in line 293 is pumped using a pump 39 and a pumped recycle olefin stream in the recycle line 296 is recycled to the first-stage oligomerization reactor 231 as described herein above.

Referring back to the olefin splitter column 261, the heavy olefin stream in the splitter bottoms line 271 may be split to provide a reboil stream in a splitter reboil line 272 which is pumped using a pump 36 and a pumped reboiled stream in line 274 is reboiled by heat exchange with a second hot diesel stream in line 283 perhaps taken from the jet fractionator bottom heat exchange stream in the jet bottoms heat exchange line 281. A reboiled stream in line 275 is fed back to the olefin splitter column 261. A heavy olefin stream is taken in a net bottoms line 273, pumped using a pump 38 and a pumped heavy olefin stream in line 277 is cooled by heat exchange with the expanded oligomerized olefin stream in line 244 in the heat exchanger 26 to provide a cooled heavy olefin stream in line 278.

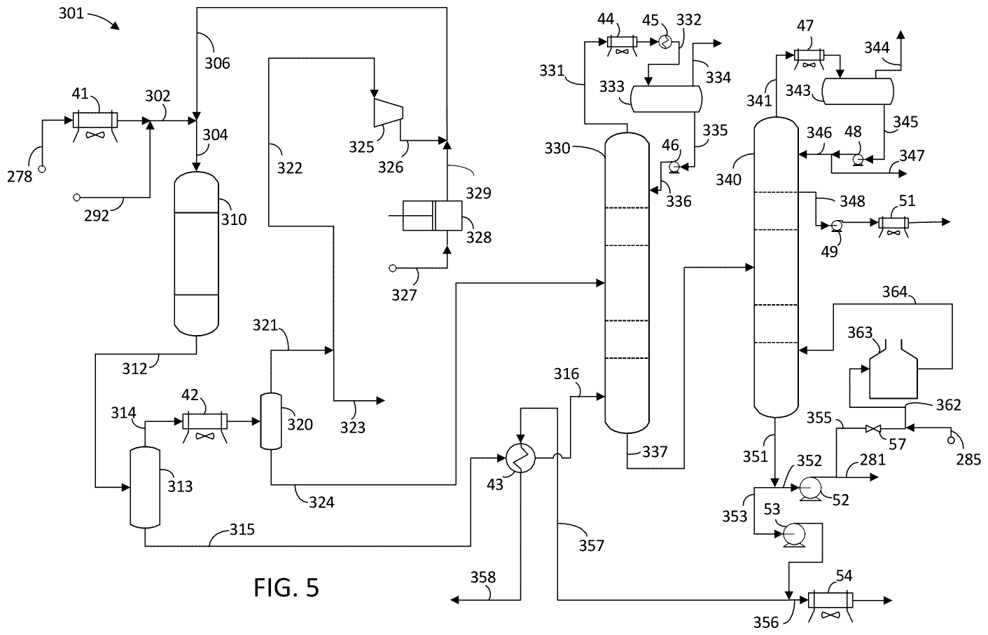

Turning to the hydrogenation section 301 in FIG. 5, the cooled heavy olefin stream in line 278 from FIG. 4 comprising distillate-range C9+ oligomerized olefins may be hydrogenated to saturate the olefinic bonds in a hydrogenation reactor 310 to provide fuels. This step is performed to ensure the product fuel meets or exceeds the thermal oxidation requirements specified in ASTM D7566-20 for Alcohol to Jet Synthesized Paraffinic Kerosene (ATJ-SPK). Additionally, hydrogenating the oligomerized heavy olefins will provide the paraffin stream that may be used as the diluent stream in line 358 in FIG. 4. The cooled heavy olefin stream in line 278 may be further cooled in a cooler 41 to produce steam and be combined with the light olefin vapor stream in line 292 from FIG. 4 to produce a combined olefin stream in line 302. The combined olefin stream in line 302 may be combined with a hydrogen stream in line 306 to provide a combined hydrogenation charge stream in line 304. The combined hydrogenation charge stream in line 304 is charged to the hydrogenation reactor 310 at a temperature of about 125° C. (257° F.) to about 204° C. (400° F.) and a pressure of about 2.8 MPa (400 psig) to about 6.9 MPa (1000 psig). In an aspect, the combined hydrogenation charge stream in line 304 may be cooled for example in a cooler and charged to the hydrogenation reactor 310. An excess of hydrogen may be employed in the hydrogenation reactor 310 to ensure complete saturation such as about 1.5 to about 5.0 of stochiometric hydrogen.

Hydrogenation is typically performed using a conventional hydrogenation or hydrotreating catalyst, and can include metallic catalysts containing, e.g., palladium, rhodium, nickel, ruthenium, platinum, rhenium, cobalt, molybdenum, or combinations thereof, and the supported versions thereof. Catalyst supports can be any solid, inert substance including, but not limited to, oxides such as silica, alumina, titania, calcium carbonate, barium sulfate, and carbons. The catalyst support can be in the form of powder, granules, pellets, or the like.

In an exemplary embodiment, hydrogenation is performed in the hydrogenation reactor 310 that includes a platinum-on-alumina catalyst, for example about 0.1 wt % to about 2 wt %, preferably about 0.5 wt % to about 0.9 wt %, platinum-on-alumina catalyst. In another embodiment, the hydrogenation catalyst comprises about 5 to about 30 wt % nickel catalyst. The hydrogenation reactor 310 converts the olefins into a paraffin product having the same carbon number distribution as the olefins, thereby forming distillate-range paraffins suitable for use as jet and diesel fuel.

A hydrogenated heavy stream discharged from the hydrogenation reactor 310 in line 312 may be separated in a hot separator 313 which provides a hydrocarbon split. In the hot separator 313 the hydrogenated heavy stream is separated into a hot hydrogenated vapor stream in an overhead line 314 and a hot hydrogenated liquid stream in the hot separator bottoms line 315. The hydrogenated heavy liquid stream in the bottoms line 315 may be heated by heat exchange with a diluent stream in line 357 before the diluent stream is recycled to the first-stage oligomerization reactor 231 in FIG. 4. The heated hydrogenated heavy liquid stream in the hot bottoms line 316 may be fed to a stripper column 330. The hot separator 313 may be operated at a temperature of about 204° C. (400° F.) to about 343° C. (650° F.) and a pressure of 2.8 MPa (400 psig) to about 6.9 MPa (1000 psig).

The hot hydrogenated vapor stream in the hot overhead line 314 may be cooled in a cooler 42 and fed to a cold separator 320. The cold separator 320 separates a cooled hot hydrogenated vapor stream in the hot overhead line 314 into a cold vapor hydrogenated stream in a cold overhead line 321 and a cold heavy hydrogenated liquid stream in a cold bottoms line 324. A purge stream in a purge line 323 may be taken from the cold vapor hydrogenated stream in the cold overhead line 321 and the remainder may be compressed in a compressor 325 to provide a compressed hydrogenated stream in line 326. The compressed hydrogenated stream in line 326 may be combined with a make-up hydrogen stream in line 329 to provide the hydrogen stream in line 306. The cold hydrogenated heavy liquid stream in the bottoms line 324 may be fed to the stripping column 330 at a feed location above that for the hot hydrogenated heavy liquid stream in the hot separator bottoms line 316. The cold separator 320 may be operated at a temperature of about 32° C. (90° F.) to about 71° C. (150° F.) and a pressure of about 2.8 MPa (400 psig) to about 4.5 MPa (650 psig).

The stripping column 330 may to remove light gases from the hot hydrogenated liquid stream in the hot bottoms line 316 and the cold hydrogenated liquid stream in the cold bottoms line 324. Both of these streams can be combined and charged to the stripping column 330 or they can be charged separately as shown. The stripping column 330 removes residual light gases from the liquid hydrogenated streams to provide a stripper overhead stream in a stripper overhead line 331 and a stripped bottom stream in a stripper bottoms line 337. The stripper overhead stream in the stripper overhead line 331 may be cooled in an air cooler 44, condensed in a condenser 45, and a cooled-condensed stripper overhead stream in line 332 is separated in a stripper receiver 333 to provide a stripper off-gas stream in a stripper receiver overhead line 334 and a condensate stream in line 335 which is refluxed to the column.

The stripper off-gas stream in a stripper receiver overhead line 334 may comprise hydrogen in substantial amount which can be recovered from the off gases. In an embodiment, the stripper off-gas stream in line 334 is passed in line 210 to the pressure swing adsorption unit 250 in FIG. 1 or FIG. 2 to recover hydrogen from the off gases after combination with the water gas shift effluent stream in line 245 from the water gas shift reactor 239.

The condensate stream in line 335 may be pumped using a pump 46 and a pumped condensate stream is refluxed to the stripping column 330 in a reflux line 336. The stripping column 330 may be operated at a bottoms temperature of about 232° C. (450° F.) to about 316° C. (600° F.) and an overhead pressure of about 207 kPa (30 psig) to about 689 kPa (100 psig).

After undergoing stripping to remove volatiles in the stripping column 330, the stripped fuel stream in the stripper bottoms line 337 may be fed to the jet fractionation column 340 without further heating. Alternatively, the stripping column 330 may be omitted upstream of the jet fractionation column 340. In the jet fractionation column 340, the stripped fuel stream may be separated into a jet off-gas stream in an overhead line 341, a green jet stream in a side line 348 from a side of the jet fractionation column 340 and a green diesel stream in a bottoms line 351. The jet fractionation column 340 may be operated at a bottoms temperature of about 288° C. (550° F.) to about 400° C. (750° F.) and an overhead pressure of about 35 kPa (5 psig) to about 350 kPa (50 psig).

The jet fractionation overhead stream in the overhead line 341 may be cooled in a cooler 47 and passed to the jet fractionation receiver 343. A condensate stream is taken in line 345 from the jet fractionation receiver 343 which is pumped to the jet fractionation column 340 using a pump 48. A reflux stream in line 348 may be taken from the condensate stream in line 345 and refluxed back to the jet fractionation column 100 in a reflux line 346. The remainder of the condensate is taken as a naphtha range product stream in line 347. Additionally, the net off gas stream comprising C4 to C8-hydrocarbons is taken in a receiver overhead line 344 from the jet fractionation receiver 343. Most of the hydrocarbons in the net off gas stream in the receiver overhead line 105 are lighter hydrocarbons and can be used accordingly.

In an aspect, the net off gas stream in line 344 from the jet fractionation column 340 may be passed in line 202 to the reforming section 205 in FIG. 1 or the partial oxidation reactor 207 in FIG. 2.

The green jet stream taken in the side line 348 comprises kerosene range C8-C18 hydrocarbons is pumped using a pump 49 and may be cooled in a cooler 51 to be taken as a jet fuel product meeting applicable SPK standards. In an alternative embodiment, the green jet stream in line 348 may be taken from the condensate stream in line 345 from the jet fractionation receiver 343 instead of refluxing all of the condensate to the column. This green jet stream taken from line 345 may have to be further stripped to remove light ends. In such an embodiment, no side line 348 would be taken to recover the green jet fuel stream.

The green diesel bottoms stream in the bottoms line 351 may be split between a reboil diesel stream in line 352 and a diesel product stream in line 353. The reboil diesel stream in line 107 is pumped using a pump 52 and may be split to provide the jet bottoms heat exchange stream 281 and a bypass bottoms stream in the bottoms bypass line 355. The jet bottoms heat exchange stream is taken in line 281 and split to provide the first hot diesel stream in line 282 which is passed to the dealkanizer column 251 to provide reboil heat and the second hot diesel stream in line 283 which is passed to the olefin splitter column 261 to provide reboil heat as shown in FIG. 4. The bypass bottoms stream in line 111 may be passed through a valve 57 and combined with the combined cooled diesel stream in line 285 from FIG. 4 to provide a jet reboil stream in line 362. The jet reboil stream in line 362 is reboiled in a fired heater 363 and a reboiled stream in line 364 is fed back to the jet fractionation column 340.

The diesel product stream in line 353 is pumped using a pump 53 and split between a diesel product stream in a diesel product line 356 and the diluent stream in line 357. The diluent stream in line 14 may be cooled by heat exchange with the hot hydrogenated heavy liquid stream in the hot separator bottoms line 315 to provide a cooled diluent stream in line 358. The cooled diluent stream in line 358 is recycled back to be mixed with the charge olefin stream in line 219a in the oligomerization section 201 in FIG. 4, to absorb the exotherm in the oligomerization reactor 231 as described hereinabove. The green diesel stream in the diluent line 357 is paraffinic, so it will be inert to the oligomerization and hydrogenation reactions to which it may be subject. The diesel product stream in the diesel product line 356 may be cooled in a cooler 54 and fed to the diesel pool.

### Example

A simulation study was conducted for the process for providing hydrogen. A material balance analysis was performed for the off-gas streams from the oligomerization feed production unit, the oligomerization section, and the hydrogenation section. The results of the material balance analysis are summarized in Table below:

| | TABLE | | | |
|---|---|---|---|---|
| | Stream Name | | | |
| | | Net off gas | | |
| | Dealkanized off- | stream of jet | Light gas stream | Stripper off-gas |
| Components | gas stream | fractionation | of demethanizer | stream |
| Hydrogen | — | 1.71 | — | Not reported |
| (lbmol/h) | | | | |
| Methane | 0.19 | 0.04 | 8.29 | trace |
| Propane | 60.85 | 14.59 | — | 1.75 |
| N-Butane | 0.47 | 1.31 | — | 3.4 |
| Isobutane | 0.15 | 4.1 | — | 11.87 |
| Total mass flow | 124.7 | 38.52 | 21.1 | 20.32 |
| rate (lb/h) | | | | |

As shown in the Table, the dealkanized off-gas stream, the net off gas stream from jet fractionation, and the demethanizer light gas stream had significant concentration of the hydrocarbon components. So, these gases may be fed to the SMR reactor or the partial oxidation reactor to make syn gas for producing hydrogen.

### SPECIFIC EMBODIMENTS

While the following is described in conjunction with specific embodiments, it will be understood that this description is intended to illustrate and not limit the scope of the preceding description and the appended claims.

A first embodiment of the disclosure is a process for providing hydrogen in a process to produce jet fuel from methanol, comprising sending a hydrocarbon rich off-gas stream to a reforming reactor or a partial oxidation reactor to produce a gas stream; sending a hydrogen rich off-gas stream to be combined with the gas stream to provide a hydrogen enhanced gas stream; and purifying the hydrogen enhanced gas stream to produce a hydrogen stream. An embodiment of the disclosure is one, any or all of prior embodiments in this paragraph up through the first embodiment in this paragraph, wherein the off-gas stream is first sent to a pre-reforming reactor and then to a water gas shift reactor. An embodiment of the disclosure is one, any or all of prior embodiments in this paragraph up through the first embodiment in this paragraph, wherein after passing through the water gas shift reactor, the gas stream is sent to a pressure swing adsorption unit to purify the hydrogen enhanced gas stream. An embodiment of the disclosure is one, any or all of prior embodiments in this paragraph up through the first embodiment in this paragraph, wherein the hydrocarbon rich off-gas stream is from at least one column selected from a dealkanizer column and a jet fractionator column or combinations thereof. An embodiment of the disclosure is one, any or all of prior embodiments in this paragraph up through the first embodiment in this paragraph, wherein the hydrogen rich off-gas stream is from at least one column selected from a demethanizer column and a stripper column or combinations thereof. An embodiment of the disclosure is one, any or all of prior embodiments in this paragraph up through the first embodiment in this paragraph, wherein the pressure swing adsorption unit treats a mixture of hydrogen, carbon dioxide, carbon monoxide and unconverted methane to produce the hydrogen stream. An embodiment of the disclosure is one, any or all of prior embodiments in this paragraph up through the first embodiment in this paragraph, wherein the pressure swing adsorption unit produces a tail gas stream comprising carbon dioxide, carbon monoxide and unconverted methane. An embodiment of the disclosure is one, any or all of prior embodiments in this paragraph up through the first embodiment in this paragraph, wherein a portion of the hydrocarbon rich off-gas stream is sent to supplement a fuel supply to a reforming reactor or a partial oxidation reactor. An embodiment of the disclosure is one, any or all of prior embodiments in this paragraph up through the first embodiment in this paragraph, wherein the tail gas stream is sent to a steam reforming reactor or a partial oxidation reactor as fuel gas. An embodiment of the disclosure is one, any or all of prior embodiments in this paragraph up through the first embodiment in this paragraph wherein the hydrocarbon rich gas stream is sent to a water gas shift reactor after the reforming reactor or the partial oxidation reactor. An embodiment of the disclosure is one, any or all of prior embodiments in this paragraph up through the first embodiment in this paragraph, wherein the hydrogen rich off-gas stream contains at least 10 mol % hydrogen. An embodiment of the disclosure is one, any or all of prior embodiments in this paragraph up through the first embodiment in this paragraph, wherein the hydrogen stream is at least 95 mol % hydrogen. An embodiment of the disclosure is one, any or all of prior embodiments in this paragraph up through the first embodiment in this paragraph, wherein the hydrogen stream is at least 98 mol % hydrogen.

A second embodiment of the disclosure is a process for providing hydrogen in a process to produce jet fuel from methanol, comprising sending a hydrocarbon rich off-gas stream to a reforming reactor or a partial oxidation reactor to produce a gas stream, wherein the hydrocarbon rich off-gas stream is taken from at least one column selected from a dealkanizer column and jet fractionator column or combinations thereof; sending a hydrogen-rich off-gas stream to be combined with the gas stream to provide a hydrogen enhanced gas stream; and purifying the hydrogen enhanced gas stream to produce a hydrogen stream. An embodiment of the disclosure is one, any or all of prior embodiments in this paragraph up through the second embodiment in this paragraph, wherein the gas stream is to a water gas shift reactor after the reforming reactor or the partial oxidation reactor. An embodiment of the disclosure is one, any or all of prior embodiments in this paragraph up through the second embodiment in this paragraph, wherein after passing through the water gas shift reactor, the gas stream is sent to a pressure swing adsorption unit to purify the hydrogen stream. An embodiment of the disclosure is one, any or all of prior embodiments in this paragraph up through the second embodiment in this paragraph, wherein the hydrogen rich off-gas stream is taken from at least one column selected from a demethanizer column and a stripper column.

A third embodiment of the disclosure is a process for providing hydrogen in a process to produce jet fuel from methanol, comprising sending a hydrocarbon rich off-gas stream to a reforming section to produce a gas stream, wherein the off-gas stream is taken from at least one column selected from a dealkanizer column and a jet fractionator column or combinations thereof; sending a hydrogen-rich off-gas stream to be combined with the gas stream to provide a hydrogen enhanced gas stream, wherein the hydrogen-rich off-gas stream is taken from at least one column selected from a demethanizer column and a stripper column or a combination thereof; and purifying the hydrogen enhanced gas stream to produce a hydrogen stream. An embodiment of the disclosure is one, any or all of prior embodiments in this paragraph up through the third embodiment in this paragraph, wherein the gas stream comprising carbon monoxide is fed to a water gas shift reactor. An embodiment of the disclosure is one, any or all of prior embodiments in this paragraph up through the third embodiment in this paragraph, wherein after passing through the water gas shift reactor, the gas stream is sent to a pressure swing adsorption unit to produce the hydrogen stream.

Without further elaboration, it is believed that using the preceding description that one skilled in the art can utilize the present disclosure to its fullest extent and easily ascertain the essential characteristics of this t disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for providing hydrogen in a process to produce jet fuel from methanol, comprising:
sending a hydrocarbon rich off-gas stream to a reforming reactor or a partial oxidation reactor to produce a gas stream;
sending a hydrogen rich off-gas stream to be combined with said gas stream to provide a hydrogen enhanced gas stream; and
purifying said hydrogen enhanced gas stream to produce a hydrogen stream.

2. The process of claim 1, wherein said off-gas stream is first sent to a pre-reforming reactor and then to a water gas shift reactor.

3. The process of claim 2, wherein after passing through the water gas shift reactor, said gas stream is sent to a pressure swing adsorption unit to purify said hydrogen enhanced gas stream.

4. The process of claim 1, wherein said hydrocarbon rich off-gas stream is from at least one column selected from a dealkanizer column and a jet fractionator column or combinations thereof.

5. The process of claim 1, wherein said hydrogen rich off-gas stream is from at least one column selected from a demethanizer column and a stripper column or combinations thereof.

6. The process of claim 3, wherein said pressure swing adsorption unit treats a mixture of hydrogen, carbon dioxide, carbon monoxide and unconverted methane to produce said hydrogen stream.

7. The process of claim 3, wherein said pressure swing adsorption unit produces a tail gas stream comprising carbon dioxide, carbon monoxide and unconverted methane.

8. The process of claim 1, wherein a portion of said hydrocarbon rich off-gas stream is sent to supplement a fuel supply to a reforming reactor or a partial oxidation reactor.

9. The process of claim 7, wherein said tail gas stream is sent to a steam reforming reactor or a partial oxidation reactor as fuel gas.

10. The process of claim 1 wherein said hydrocarbon rich gas stream is sent to a water gas shift reactor after said reforming reactor or said partial oxidation reactor.

11. The process of claim 1, wherein said hydrogen rich off-gas stream contains at least 10 mol % hydrogen.

12. The process of claim 1, wherein said hydrogen stream is at least 95 mol % hydrogen.

13. The process of claim 1, wherein said hydrogen stream is at least 98 mol % hydrogen.

14. A process for providing hydrogen in a process to produce jet fuel from methanol, comprising:
sending a hydrocarbon rich off-gas stream to a reforming reactor or a partial oxidation reactor to produce a gas stream, wherein said hydrocarbon rich off-gas stream is taken from at least one column selected from a dealkanizer column and jet fractionator column or combinations thereof;
sending a hydrogen-rich off-gas stream to be combined with said gas stream to provide a hydrogen enhanced gas stream; and
purifying said hydrogen enhanced gas stream to produce a hydrogen stream.

15. The process of claim 14, wherein said gas stream is to a water gas shift reactor after said reforming reactor or said partial oxidation reactor.

16. The process of claim 15, wherein after passing through the water gas shift reactor, said gas stream is sent to a pressure swing adsorption unit to purify said hydrogen stream.

17. The process of claim 14, wherein said hydrogen rich off-gas stream is taken from at least one column selected from a demethanizer column and a stripper column.

18. A process for providing hydrogen in a process to produce jet fuel from methanol, comprising:
sending a hydrocarbon rich off-gas stream to a reforming section to produce a gas stream, wherein said off-gas stream is taken from at least one column selected from a dealkanizer column and a jet fractionator column or combinations thereof;
sending a hydrogen-rich off-gas stream to be combined with said gas stream to provide a hydrogen enhanced gas stream, wherein said hydrogen-rich off-gas stream is taken from at least one column selected from a demethanizer column and a stripper column or a combination thereof; and
purifying said hydrogen enhanced gas stream to produce a hydrogen stream.

19. The process of claim 18, wherein said gas stream comprising carbon monoxide is fed to a water gas shift reactor.

20. The process of claim 19, wherein after passing through the water gas shift reactor, said gas stream is sent to a pressure swing adsorption unit to produce said hydrogen stream.
